(19) United States
(12) Patent Application Publication
(10) Pub. No.: US 2006/0157529 A1
(43) Pub. Date: Jul. 20, 2006

(54) Device for providing sufficient time to allow piston of pneumatic nailers to move backward

(76) Inventor: Yi-Kuan Lee, Taichung City (TW)

Correspondence Address: YI-KUAN LEE;3F-5, NO 22, Lane 146, Der-Fu Road, South Area, Taichung City, 402, TW

(21) Appl. No.: 11/035,465

(22) Filed: Jan. 18, 2005

(51) Int. Cl. B25C 1/04

(52) U.S. Cl. 227/130; 227/8

(57) ABSTRACT

A device for providing sufficient time to allow the piston to move backward completely of a nailer includes a movable member engaged with a front open end of the cylinder in the barrel of the nailer and a fixed member which is matched with the movable member. The movable member is pushed toward the fixed member by the piston when firing a nail and a passage is defined between the movable member and the fixed member so as to introduce air into the cylinder to push the piston backward. A space is defined between the movable member and the inner periphery of the cylinder when the movable member is moved toward the fixed member. A tiny hole is defined through the wall of the cylinder and release the air in the space slowly so that the passage is not sealed for a period of time such that the piston has sufficient time to move back.

### FIELD OF THE INVENTION

The present invention relates to a pneumatic nailer and more particularly, to a device for providing sufficient time to allow the piston to move backward completely.

### BACKGROUND OF THE INVENTION

A conventional pneumatic nailer generally includes a cylinder received in the barrel and a piston is movably received in the cylinder and moved by pressurized air which is introduced from air paths in the handle and the barrel. The piston is connected to a piston rod which is movably inserted into a nose connected to a front end of the barrel and nails are fed into the nose and ejected by the piston rod. The piston is cable to be moved back and forth continuously so that the nails can be ejected one by one. However, during continuous ejection processes, it is noted that the power that ejects the nails is less than the first one and two ejections. This is because the piston is not yet moved backward to its limit position and pressurized air pushes it forth again. In other words, the length of stroke of the piston is shorter and shorter so that the pneumatic power applied to the nails is not sufficient to eject the nails as desired.

The present invention intends to provide a device located at a front open end of the cylinder and includes a passage for introducing air into the front section of the cylinder to push the piston backward. It takes a period of time to close the

### SUMMARY OF THE INVENTION

The present invention relates to a pneumatic nailer that comprises a cylinder located in the barrel and an ejection rod is connected to the piston. A nose is connected to a front end of the barrel and connected to a magazine. The ejection rod is movably inserted into the nose. An end cap IS connected to a rear end of the barrel and a release path is defined in the end cap. The release path is in communication with an interior of the barrel. An end member is movably received in the barrel and has a first end facing a rear open end of the cylinder and a second end of the end member movably seals the release path. A spring is biased between the end cap and the second end of the end member. A device includes a movable member movably received in a front open end of the cylinder and a fixed member fixed to the barrel. The movable member is engaged with the fixed member to seal the front open end of the cylinder. A passage is defined between the movable member and the fixed member when the movable member is pushed by the piston toward the fixed member. The passage is in communication with an interior of the cylinder. The cylinder includes an enlarged inner diameter portion so as to form a shoulder in the inner periphery of the cylinder. A hole is defined through a wall of the enlarged inner diameter portion. The movable member has an enlarged outer periphery which is matched with the shoulder of the cylinder. The movable member is pushed a distance toward the fixed member by the piston and a space is defined between the shoulder and the enlarged outer periphery of the movable member. The hole is in communication with the space and is so small such that the air in the space is released via the hole slowly and the passage introduces air into the cylinder to push the piston backward completely.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a cross sectional view to show the pneumatic nailer of the present invention;

FIG. 2 shows the piston is moved toward the device when the trigger is squeezed;

FIG. 3 shows the movable member is pushed a distance by the piston member to define a passage between the movable member and the fixed member;

FIG. 4 shows that the piston is moved hack by the air introduced via the passage, and

FIG. 5 shows a rear end of the pneumatic nailer.

### DETAILED DESCRIPTION OF THE PREFERRED EMBODIMENT

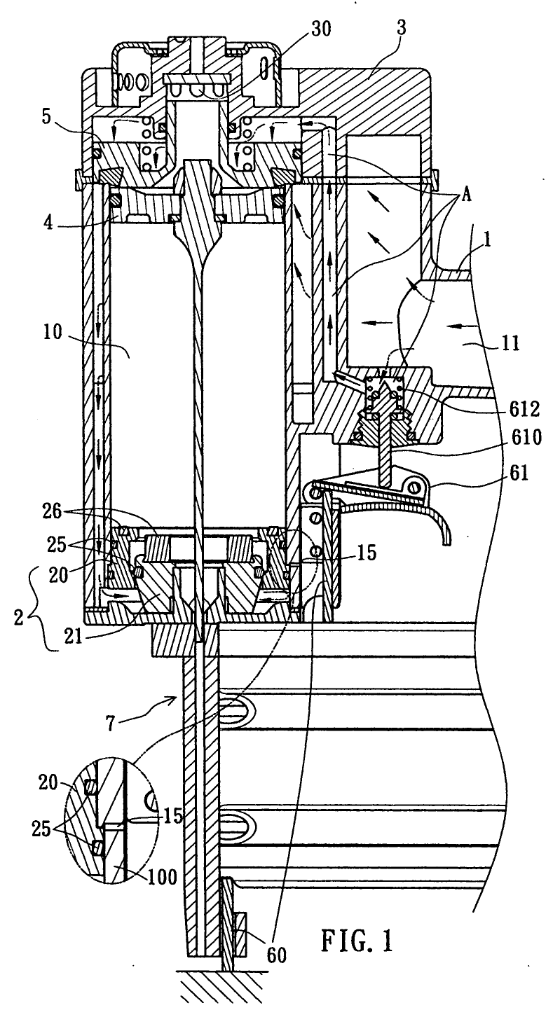

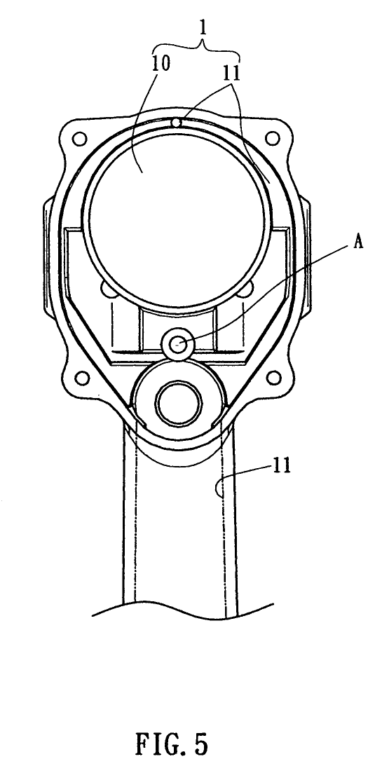

Referring to FIGS. 1, 2 and 5, the pneumatic nailer of the present invention comprises a handle 1 and a barrel connected to the handle 1 in which a main path 11 is defined so as to be connected to a hose (not shown) for introducing pressurized air into the main path 11. A trigger 61 is pivotably connected to the handle 1 and is connected to a rod 610 which is mounted by a spring 612 so as to be movably seal path “A” which allows air enters a space between an end member 5 and an end cap 3 which is fixed to a rear end of the barrel. A cylinder 10 is located in the barrel and has an ejection rod extending therefrom. A nose 7 is connected to a front end of the barrel and is connected to a magazine which feeds nails into the nose 7 and the nail is to be ejected out from the nose 7 by the ejection rod which is movably inserted into the nose 7. A release path 30 is defined in the end cap 3 and in communication with an interior of the barrel so as to release the air in the cylinder 10 when the piston 4 is moved back. The end member 5 is movably received in the barrel and has a first end facing a rear open end of the cylinder 10 and a second end of the end member 5 movably seals the release path 30. A spring is biased between the end cap 3 and the second end of the end member 5. When the trigger 61 is not yet squeezed, the air enters the space between an end member 5 and an end cap 3 so as to push the end member 5 to seal the rear open end of the cylinder 10.

A device 2 includes a movable member 20 movably received in a front open end of the cylinder 10 and a fixed member 21 is fixed to the barrel. The movable member 20 and the fixed member 21 each have a plurality of buffer pieces 26 which are located to face the piston 4. A plurality of seals 25 are engaged with the movable member 20 and the fixed member 21 to prevent leakage. The movable member 20 is movable linearly and has a recess in which the fixed member 21 is located. The recess of the movable member 20 has a tapered inn periphery which is matched with an tapered outer periphery of the fixed member 21 so as to seal the front open end of the cylinder 10.

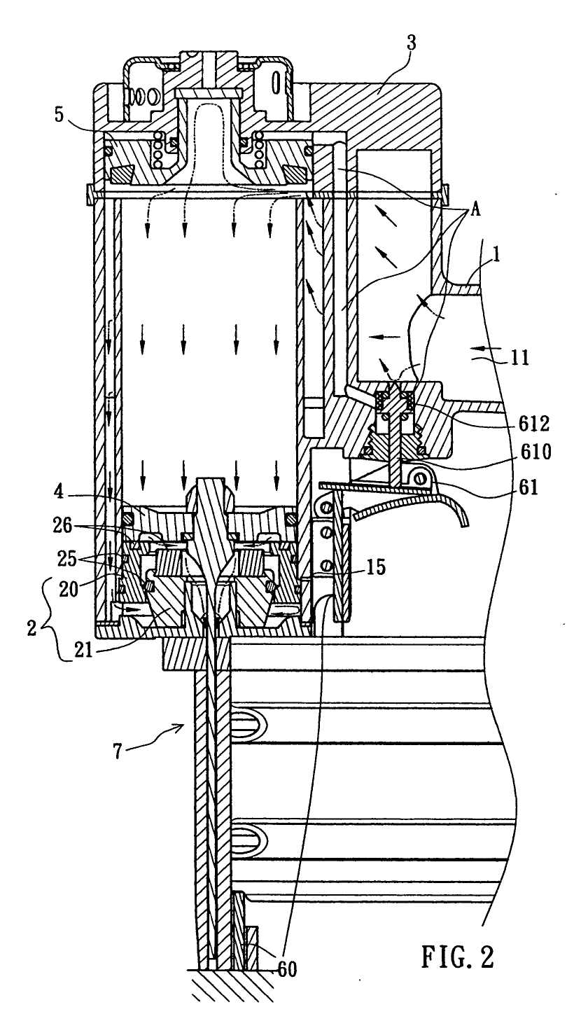

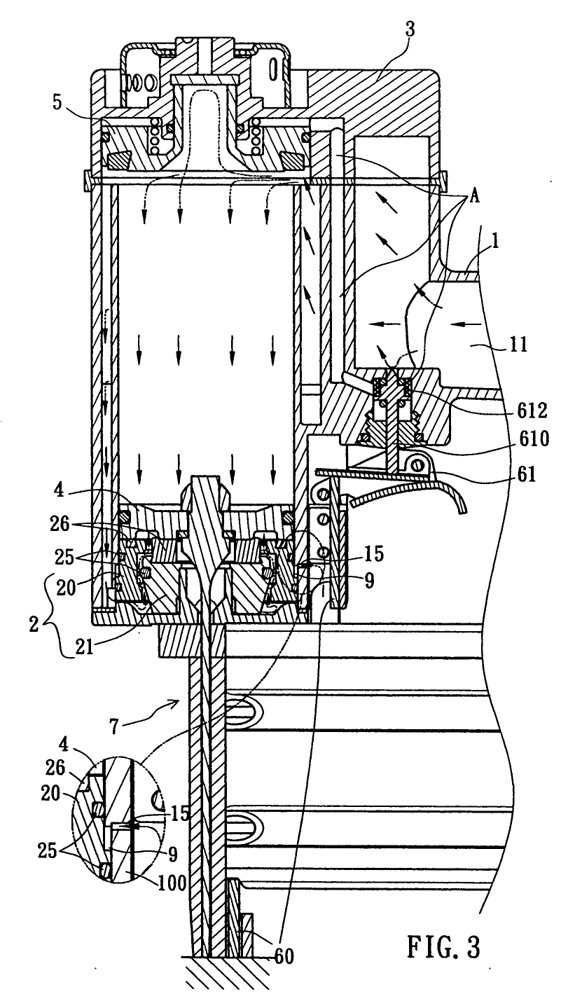

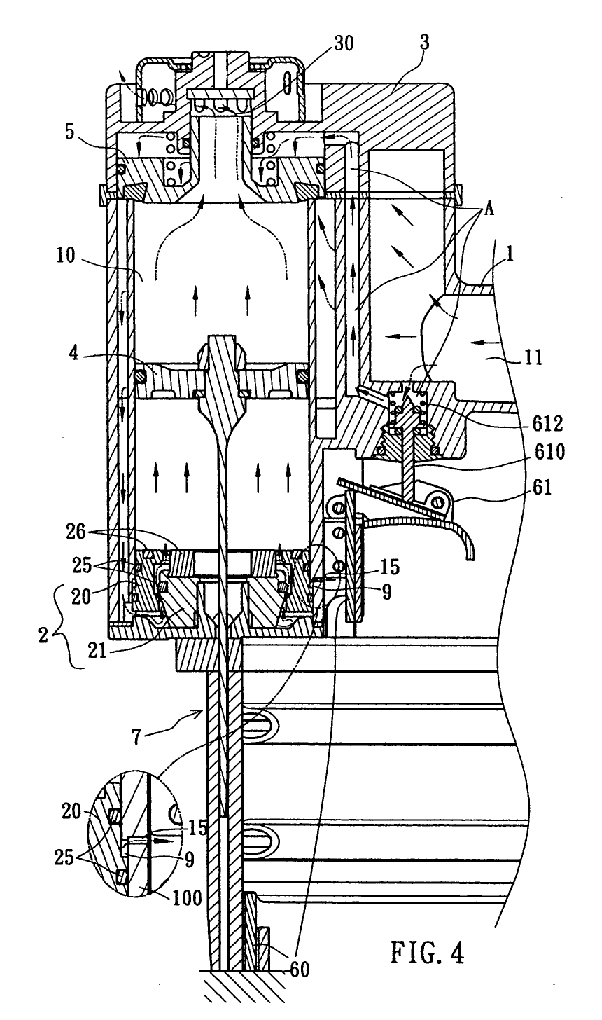

Referring to FIGS. 2 and 3, when pushing the safety links 60 backward and between the end cap 3 and the end member 5 is reduced and the pressure pushes the end member 5 toward the end cap 3 and pushes the piston 4 toward the device. The piston 4 is pushed and the piston rod ejects a nail in the nose 7 and the piston 4 pushes the movable member 20 linearly a distance toward the fixed member 21. A passage is then defined between the inner tapered periphery of the movable member 20 and the outer tapered outer periphery of the fixed member 21 as shown in FIG. 4. The passage is in communication with the interior of the cylinder 10.

The cylinder 10 including an enlarged inner diameter portion 100 so as to form a shoulder in the inner periphery of the cylinder 10. A tiny hole 15 is defined through a wall of the enlarged inner diameter portion 100. The movable member 20 has an enlarged outer periphery which is matched with the shoulder of the cylinder 10. When the movable member 20 is pushed a distance toward the fixed member 21 by the piston 4, a space 9 is defined between the shoulder and the enlarged outer periphery of the movable member 20. The hole 15 is in communication with the space 9 so that after the piston 4 is about to move back by the pressurized air via the passage, the pressure in the space 9 performs a damper to slow down the movement of the movable member 20 and the air in the space 9 releases from the tiny hole 15 slowly because the tiny hole 15. This keep the passage not being closed for a period of time and the piston 4 has sufficient time to move back to its ready-to-fire position as shown in FIG. 1.

By the device, the piston 4 moves back completely so that every shoot is in its full force when the user continuously shoots the nails.

While we have shown and described the embodiment in accordance with the present invention, it should be clear to those skilled in the art that further embodiments may be made without departing from the scope of the present invention.

What is claimed is:

1. A pneumatic nailer comprising:
a handle and a barrel connected to the handle in which a main path is defined, a trigger pivotably connected to the handle, a cylinder located in the barrel and having an ejection rod extending therefrom, a nose connected to a front end of the barrel and adapted to be connected to a magazine, the ejection rod movably inserted into the nose, an end cap connected to a rear end of the barrel, a release path defined in the end cap and in communication with an interior of the barrel, an end member movably received in the barrel and having a first end facing a rear open end of the cylinder and a second end of the end member movably sealing the release path, a spring biased between the end cap and the second end of the end member;
a device including a movable member movably received in a front open end of the cylinder and a fixed member fixed to the barrel, the movable member engaged with the fixed member to seal the front open end of the cylinder, a passage defined between the movable member and the fixed member when the movable member is pushed by the piston toward the fixed member, the passage being in communication with an interior of the cylinder, and
the cylinder including an enlarged inner diameter portion so as to form a shoulder in the inner periphery of the cylinder, a hole defined through a wall of the enlarged inner diameter portion, the movable member having an enlarged outer periphery which is matched with the shoulder of the cylinder, the movable member being pushed a distance toward the fixed member by the piston and a space defined between the shoulder and the enlarged outer periphery of the movable member, the hole being in communication with the space.

2. The nailer as claimed in claim 1, wherein the movable member and the fixed member each have a plurality of buffer pieces which are located to face the piston.

3. The nailer as claimed in claim 1, wherein the movable member is movable linearly and has a recess in which the fixed member is located, the recess having a tapered inn periphery which is matched with an tapered outer periphery of the fixed member so that when the movable member moves linearly by the piston, the passage is defined between the inner tapered periphery of the movable member and the outer tapered outer periphery of the fixed member.
